(19) United States
(12) Patent Application Publication
(10) Pub. No.: US 2014/0088959 A1
(43) Pub. Date: Mar. 27, 2014

(54) BAND EXTENSION APPARATUS AND BAND EXTENSION METHOD

(71) Applicant: Oki Electric Industry Co., Ltd., Tokyo (JP)

(72) Inventor: Masaru FUJIEDA, Tokyo (JP)

(73) Assignee: Oki Electric Industry Co., Ltd., Tokyo (JP)

(21) Appl. No.: 13/946,252

(22) Filed: Jul. 19, 2013

(30) Foreign Application Priority Data
Sep. 21, 2012 (JP) 2012-207800

(51) Int. Cl. G10L 21/034

(52) U.S. Cl. CPC G10L 21/034
USPC 704/225

(57) ABSTRACT

A band extension apparatus is provided. The band extension apparatus extends a narrow-band speech signal whose frequency band has been restricted to an arbitrary input band, such that the extension band includes signal components in an arbitrary extension band. The arbitrary extension band is a frequency band outside the input band.

### CROSS REFERENCE TO RELATED APPLICATION(S)

This application is based upon and claims benefit of priority from Japanese Patent Application No. 2012-207800, filed on Sep. 21, 2012, the entire contents of which are incorporated herein by reference.

### BACKGROUND

The present invention relates to a band extension apparatus and a band extension method, and is applicable to a band extension apparatus and a band extension method that improves the quality of a speech signal output by telephony equipment, and outputs a speech signal with high clarity.

The frequency band of speech signals transmittable by telephony equipment is approximately from 300 Hz to 3.4 kHz.

With a narrow-band speech signal that is band-limited to such a telephony band, the quality becomes muffled compared to the original voice, posing a problem in that words become difficult to hear.

In order to solve this problem, a band extension technique has been proposed, in which voice clarity is improved by adding an extension signal at or above 3.4 kHz for extension to a wideband signal.

The inventor focuses on an approach that generates an extension signal by applying predetermined processing in the time domain to a narrow-band speech signal, and generates an extended wideband speech signal by adding together the narrow-band speech signal and the generated extension signal. With this approach, in almost all cases the predetermined processing in the time domain is non-linear processing. Also, many methods utilize suitable noise as all or part of the extension signal. Since processing is conducted in the time domain and does not require codebooks, this technique has the merit of being able to realize band extension with light calculation and few resources.

A most basic embodiment of the above approach of the related art will now be briefly described with reference to FIG. 1. In FIG. 1, a voice band extension apparatus of the related art includes an upsampling processor 101, a band-pass filtering processor 102, a full-wave rectification processor 103, a high-pass filtering processor 104, a multiplication processor 106, and an addition processor 107.

The upsampling processor 101 upsamples a narrow-band speech signal with 8 kHz sampling to a speech signal with 16 kHz sampling, for example.

The band-pass filtering processor 102 obtains a filtered signal with a band from 2 kHz to 4 kHz, for example. The full-wave rectification processor 103 extends the band of the filtered signal to a full band from 0 Hz to 8 kHz. The high-pass filtering processor 104 filters an extension band at or above 4 kHz, for example, and applies the result to be an extension signal. The multiplication processor 106 multiplies the extension signal by a predefined extension gain 105 to adjust the amplitude in the extension signal. The addition processor 107 adds together the upsampled narrow-band speech signal and the amplitude-adjusted extension signal, and outputs an extended wideband speech signal.

In FIG. 1, the extension gain 105 is a constant, and the extension gain 105 is set by experience so that this technique will operate effectively in most cases. However, since the amplitude of the extension signal and the amplitude in the extension band of an actual wideband speech signal typically are not proportional, the quality of the extended wideband speech signal thus output may be degraded.

Several techniques have been developed in order to make this extension gain variable (see Japanese Unexamined Patent Application Publication No. 2007-310296 (hereinafter referred to as Patent Document 1), Japanese Unexamined Patent Application Publication No. 2009-134260 (Japanese Patent No. 4733727) (hereinafter referred to as Patent Document 2), and Japanese Unexamined Patent Application Publication No. 2004-151423 (Japanese Patent No. 4433668) (hereinafter referred to as Patent Document 3)).

The technique disclosed in Patent Document 1 improves the quality of the extended wideband speech signal by reflecting the spectral characteristics to the extension gain of the narrow-band speech signal, and by setting appropriate extension gains for voiced and unvoiced sound, respectively. More specifically, two spectral characteristics analysis methods are introduced. The first method assumes that the power relationship between the low band and the high band in the narrow band is also applicable by analogy to the power relationship between the narrow band and the extension band, and thus sets the power ratio of the two bands into which the narrow band is divided to the extension gain. The second method computes second-order line spectral pairs (LSP) coefficients. Since the magnitude of these coefficients indicates the frequency at which spectral characteristics is large, and since the difference between the two coefficients corresponds to the degree of power concentration, the second method computes the extension gain by treating these coefficients as parameters that enable estimation of the power in the extension band.

The technique disclosed in Patent Document 2 evenly divides the input band into four bands, calculates the cumulative power or the sum of absolute amplitude values in the second-lowest and third-lowest bands for these four bands, and determines the extension gain on the basis of a ratio obtained by dividing the cumulative power or the sum of absolute amplitude value in the third band by the cumulative power or the sum of absolute amplitude value in the second band. Two examples of extension gain determination methods are given. The first is a method that applies a gain coefficient to the extension gain, and the gain coefficient is one selected from among multiple predetermined gain coefficients on the basis of the magnitude relation between the above ratio and a predetermined threshold. The other is a method that obtains the extension gain by multiplying the above ratio by a suitable coefficient.

The technique disclosed in Patent Document 3 shifts spectral parameters expressing the spectral characteristics towards the higher frequency, converts the spectral parameters into filter coefficients, and obtains an extended wideband speech signal by filtering a noise signal laid in the extension band using the filter coefficients and superposing the results with the narrow-band speech signal. Additionally, the amount of the above noise signal to superpose (corresponding to the extension gain) is adjusted on the basis of the result of a voiced/unvoiced determination made using the maximum autocorrelation coefficient.

### SUMMARY

However, with the techniques described in the above-mentioned Patent Documents 1, 2 and 3, problems like the following may occur.

The techniques described in Patent Document 1 and Patent Document 2 implement the computation of extension gain with singular systems of computational processing, and thus are potentially problematic in that universal estimation with respect to phonological changes, particularly with respect to voiced and unvoiced sound, is difficult.

Meanwhile, the technique described in Patent Document 3 adjusts the amount of the noise signal to superpose on the basis of a voiced/unvoiced determination, and thus the extension characteristics become discontinuous at the instant of the determination result being switched. This is potentially problematic in that unnatural noise may be produced, particularly in segments in which the determination result alternates in short cycles.

Thus, it is desirable to provide a band extension apparatus and a band extension method that can estimate a suitable amplitude value in extension band irrespective of phonological changes, and without a voiced/unvoiced determination.

In order to solve one or more of the above-described problems, according to a first aspect of the present invention, there is provided a band extension apparatus that extends a narrow-band speech signal whose frequency band has been restricted to an arbitrary input band, so as to include signal components in an arbitrary extension band that is a frequency band outside the input band, the band extension apparatus including: (1) an average amplitude computing unit configured to compute a short-term average amplitude of the narrow-band speech signal from the narrow-band speech signal; (2) a feature extractor configured to compute, from the narrow-band speech signal, a feature value relating to either or both of an amplitude in the narrow-band speech signal and a spectral shape in the input band; (3) an amplitude value estimating unit configured to compute a directly estimated amplitude value by directly estimating the short-term average amplitude in the extension band on the basis of the feature value from the feature extractor; (4) an amplitude ratio estimating unit configured to compute, on the basis of the feature value from the feature extractor, an estimated amplitude ratio that is an estimated value for a ratio of the short-term average amplitude in the extension band with respect to the short-term average amplitude in the input band; (5) a multiplier configured to estimate the short-term average amplitude in the extension band and computes an input band-dependent estimated amplitude value by multiplying the short-term average amplitude in the input band by the estimated amplitude ratio; (6) an amplitude value determiner configured to compute, on the basis of the directly estimated amplitude value and the input band-dependent estimated amplitude value, a determined amplitude value as a final estimated value for the short-term average amplitude in the extension band; (7) an extension signal generator configured to generate, on the basis of the narrow-band speech signal, an extension signal having the signal components in the extension band; (8) an extension signal amplitude adjuster configured to adjust the amplitude of the extension signal such that the short-term average amplitude of the extension signal becomes the determined amplitude value; and (9) an adder configured to add the narrow-band speech signal and the extension signal whose amplitude is adjusted by the extension signal amplitude adjuster.

According to a second aspect of the present invention, there is provided a band extension method of extending a narrow-band speech signal whose frequency band has been restricted to an input band, so as to include signal components in an arbitrary extension band that is a frequency band outside the input band, the band extension method including: (1) computing a short-term average amplitude of the narrow-band speech signal from the narrow-band speech signal; (2) computing, from the narrow-band speech signal, a feature value relating to either or both of an amplitude in the narrow-band speech signal and a spectral shape in the input band; (3) computing a directly estimated amplitude value by directly estimating the short-term average amplitude in the extension band on the basis of the feature value; (4) computing, on the basis of the feature value, an estimated amplitude ratio that is an estimated value for a ratio of the short-term average amplitude in the extension band with respect to the short-term average amplitude in the input band; (5) estimating the short-term average amplitude in the extension band and computing an input band-dependent estimated amplitude value by multiplying the short-term average amplitude in the input band by the estimated amplitude ratio; (6) computing, on the basis of the directly estimated amplitude value and the input band-dependent estimated amplitude value, a determined amplitude value as a final estimated value for the short-term average amplitude in the extension band; (7) generating, on the basis of the narrow-band speech signal, an extension signal having the signal components in the extension band; (8) adjusting the amplitude of the extension signal such that the short-term average amplitude of the extension signal becomes the determined amplitude value; and (9) adding the narrow-band speech signal to the extension signal whose amplitude is adjusted.

According to an aspect of the present invention, the average amplitude in the extension band of an original wideband speech signal is accurately reproduced irrespective of phonology, and a natural and clear wideband speech signal is obtained without producing noise even when the phonology changes.

### BRIEF DESCRIPTION OF THE DRAWINGS

FIG. 1 is a block diagram illustrating an exemplary configuration of a basic voice band extension method of the related art;

FIG. 2 is a block diagram illustrating an exemplary configuration of a voice band extension apparatus according to a first embodiment;

FIG. 3 is a graph illustrating an average amplitude spectrum of voiced sound for the purpose of describing a mechanism that improves the clarity and naturalness of an extended wideband signal;

FIG. 4 is a graph illustrating an average amplitude spectrum of unvoiced sound for the purpose of describing a mechanism that improves the clarity and naturalness of an extended wideband signal;

FIG. 5 is a block diagram illustrating an exemplary configuration of a voice band extension apparatus according to a second embodiment;

FIG. 6 is a graph illustrating an average amplitude spectrum of sound;

FIG. 7 is a block diagram illustrating an exemplary configuration of a voice band extension apparatus according to a third embodiment;

FIG. 8 is a block diagram illustrating an exemplary configuration of a voice band extension apparatus according to a fourth embodiment;

FIG. 9 is a block diagram illustrating an exemplary configuration of a voice band extension apparatus according to a fifth embodiment; and

FIG. 10 is a block diagram illustrating an exemplary configuration of a voice band extension apparatus according to a sixth embodiment.

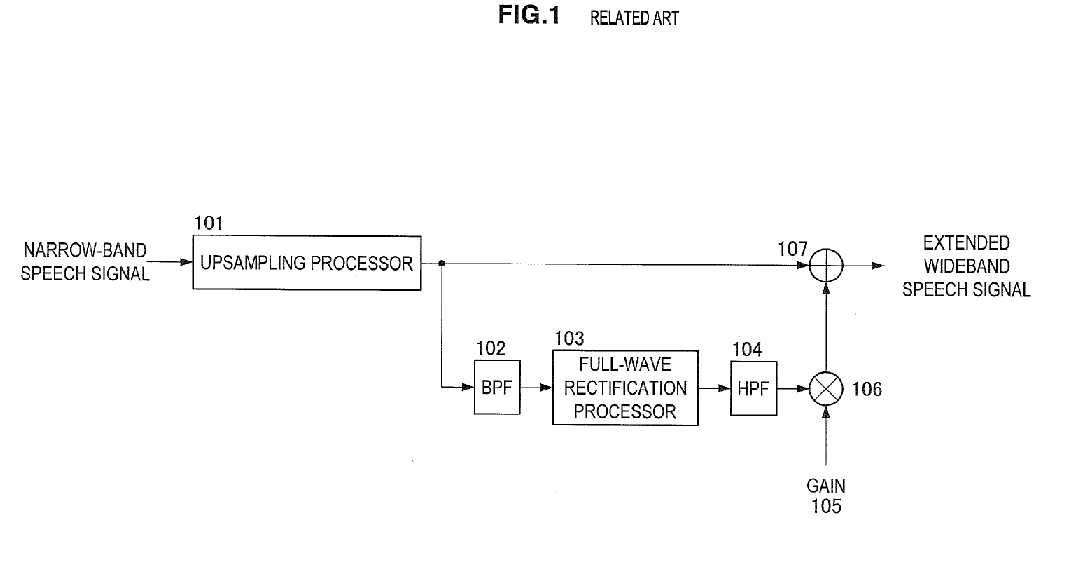

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### (A) Basic Concept of Present Invention

Hereinafter, the mechanism for the basic concept of the present invention that improves the clarity and naturalness of an extended wideband signal will be described first.

An important feature of the present invention is that the original average amplitude in the extension band is estimated by two different estimation techniques.

First, the properties of a first quantity to estimate, the amplitude value, will be described. The spectral shape is not always continuous when viewed globally (when viewed over the whole range from 0 Hz to 8 kHz).

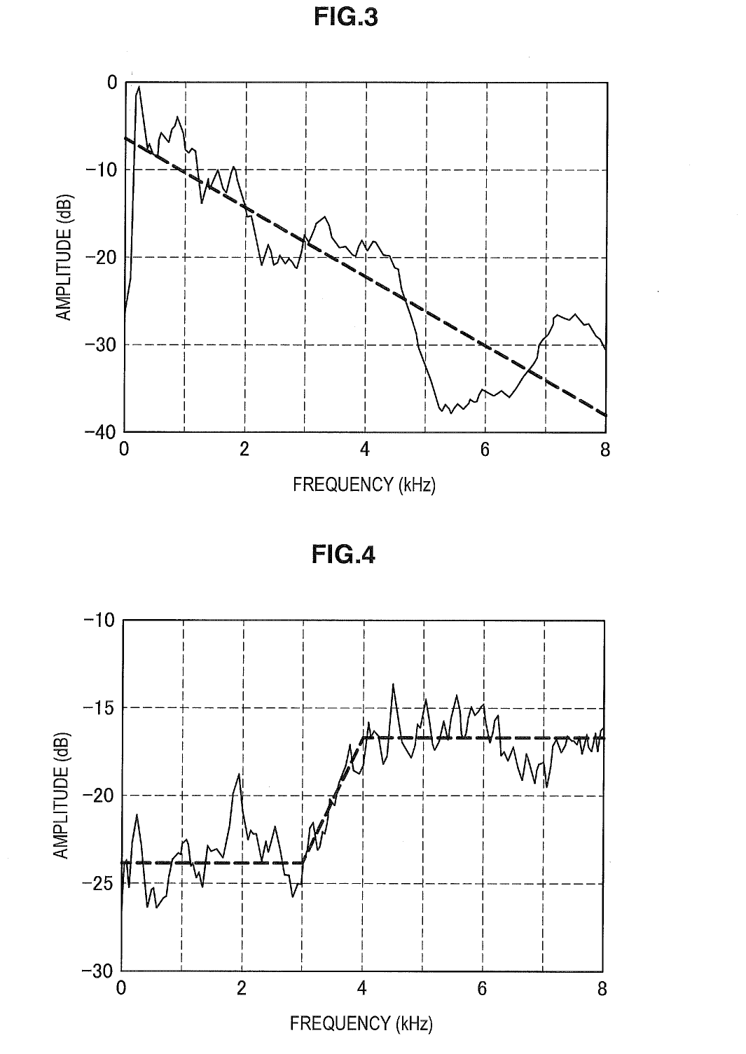

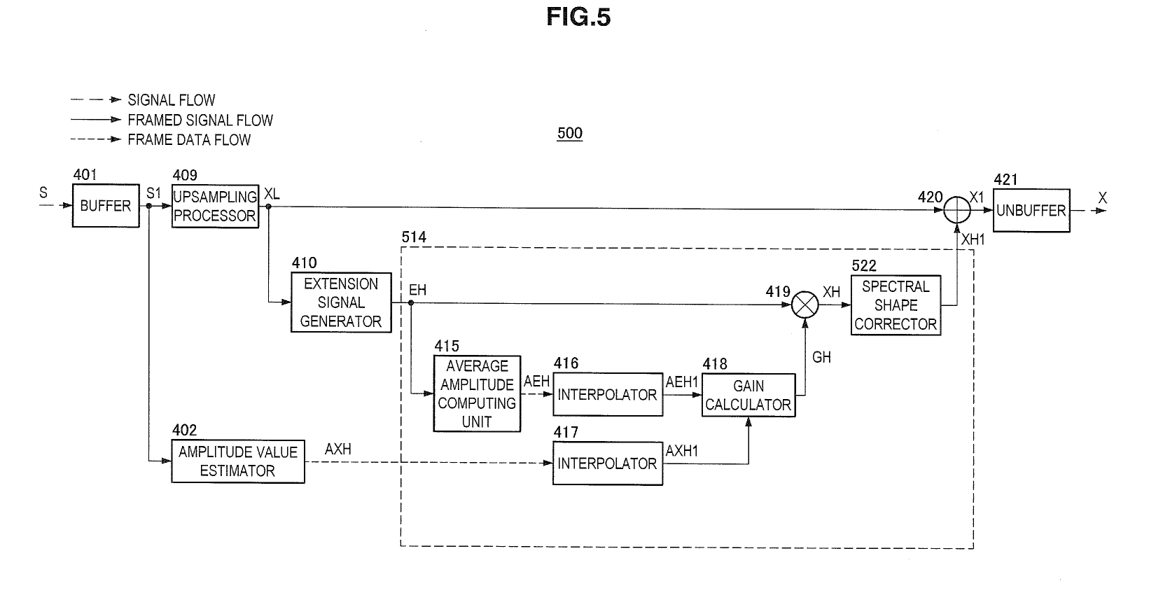

FIG. 3 is a graph illustrating an average amplitude spectrum of voiced sound. FIG. 4 is a graph illustrating an average amplitude spectrum of unvoiced sound. In FIGS. 3 and 4, thin solid lines indicate the average amplitude spectra, and bold broken lines indicate rough amplitude shapes of the average amplitude spectra.

The spectral shape of the voiced sound drops sharply in power near 5 kHz, but steadily declines overall as the frequency increases. The spectral shape of the unvoiced sound sharply increases in power between 3 kHz and 4 kHz, but is flat in other bands, and thus is better characterized as discontinuous rather than rising as the frequency increases.

On the other hand, when viewed locally (the case of focusing on a width of approximately 100 Hz to 500 Hz), the spectral shapes can be seen to be mostly continuous for both the voiced sound and the unvoiced sound. In other words, even though the spectral shape is discontinuous globally, the change in the spectral shape is smooth locally. Consequently, by utilizing the property that unvoiced sound has a “somewhat strong component” in the band around 3 kHz, stable estimation of the average amplitude in the extension band is enabled.

However, the assumption that the extension band is stronger than the “somewhat strong component” is not always satisfied. For example, in the case of voiced speech, the true average amplitude in the extension band is smaller than the average amplitude in the input band. Consequently, the estimated average amplitude in the extension band, which is referred to as a directly estimated amplitude value, has the disadvantage that it is estimated larger than the true value when voiced.

Next, the properties of a second quantity to estimate, the amplitude ratio, will be described. A major difference between the two is that whereas the above-described direct estimation of amplitude value does not depend on the input band, the average amplitude in the extension band as determined on the basis of the amplitude ratio estimation discussed herein does depend on the input band.

In the case where the true amplitude ratio is small to some degree (vowels and voiced consonants, for example), the average amplitude in the extension band can be stably and highly accurately estimated by applying the slope of the input band spectrum to the extension band. However, in the case where the actual amplitude ratio is large (unvoiced consonants, for example), the input band is extremely small compared to the extension band, and thus the value of the actual amplitude ratio becomes unstable, making estimation difficult. Consequently, an input band-dependent estimated amplitude value computed from estimated amplitude ratios has the disadvantage that it is estimated larger than the true value when unvoiced.

Given the above, stable and highly accurate estimation can be realized irrespective of phonology by applying the input band-dependent estimated amplitude value as the determined amplitude value when the input band-dependent estimated amplitude value is small, and applying the directly estimated amplitude value as the determined amplitude value when the input band-dependent estimated amplitude value is large.

Specifically, the two estimated values may be switched by “applying the determined amplitude value to be the smaller of the directly estimated amplitude value and the input band-dependent estimated amplitude”. Furthermore, since the smaller of the two estimated values is always selected, this switching method has merit in that the determined amplitude value becomes continuous temporally.

### (B) First Embodiment

Hereinafter, a band extension apparatus and a band extension method according to a first embodiment of the present invention will be described in detail with reference to the drawings.

### (B-1) Configuration and Operation of First Embodiment

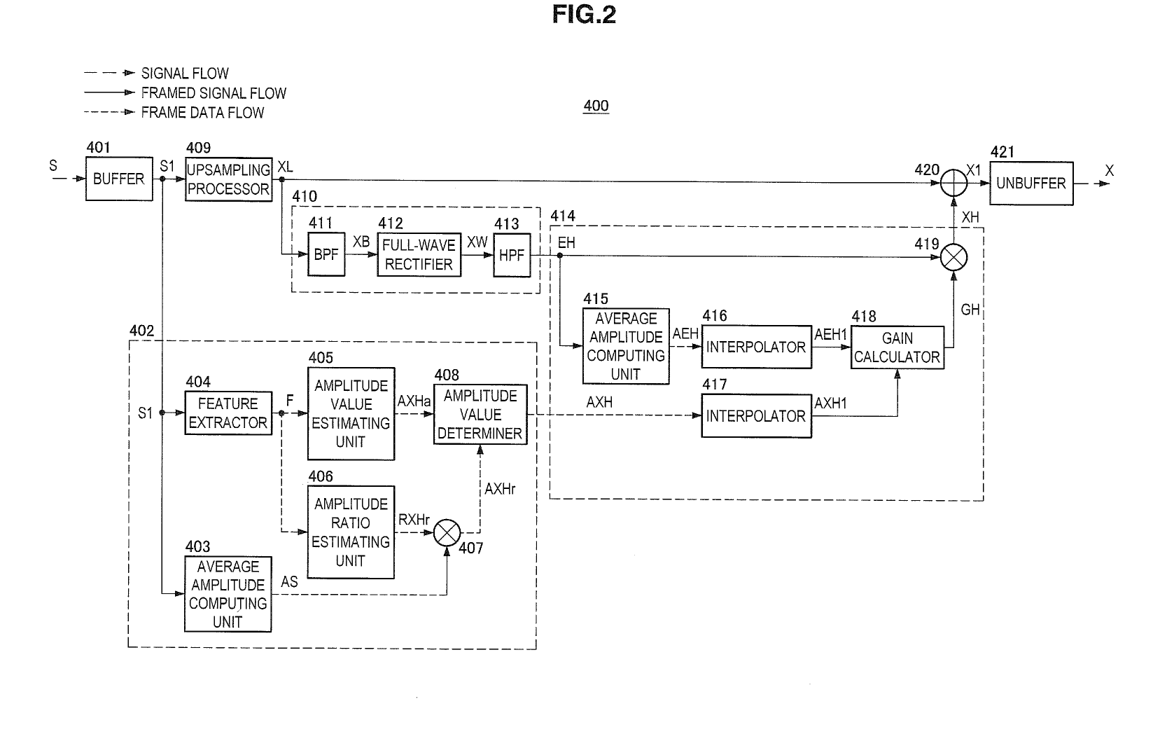

FIG. 2 is a block diagram illustrating an exemplary configuration of a voice band extension apparatus according to the first embodiment.

In FIG. 2, the voice band extension apparatus 400 of the first embodiment includes a buffer 401, an amplitude value estimator 402, an upsampling processor 409, an extension signal generator 410, an extension signal amplitude adjuster 414, an adder 420, and an unbuffer 421.

In FIG. 2, broken-line arrows represent the flow of a signal, solid-line arrows represent the flow of a framed signal discussed later, and dotted-line arrows represent the flow of frame data discussed later.

Also, a narrow-band speech signal S having a band from 0 Hz to 4 kHz (corresponding to the input band) in the form of an input digital speech signal is input to the voice band extension apparatus 400 in FIG. 2. The voice band extension apparatus 400 adds an extension signal to the narrow-band speech signal S to generate an extended wideband speech signal X, where the extension signal has a band from 4 kHz to 8 kHz (corresponding to the extension band), and the extended wideband speech signal X has a band from 0 Hz to 8 kHz. And the voice band extension apparatus 400 outputs the extended wideband speech signal as a speech signal with higher clarity.

The buffer 401 buffers the narrow-band speech signal S and collectively outputs N samples for every fixed number of samples N. For example, in the case where the sampling frequency of the narrow-band speech signal S is 8 kHz, N=80 samples is set to output every 10 ms, whereas N=160 samples is set to output every 20 ms. A speech signal collected every N samples in this way is herein designated a framed signal. The framed signal of S is denoted S1. The framed signal S1 of the obtained narrow-band speech signal is supplied to the amplitude value estimator 402 and the upsampling processor 409.

The amplitude value estimator 402 includes an average amplitude computing unit 403, a feature extractor 404, an amplitude value estimating unit 405, an amplitude ratio estimating unit 406, a multiplier 407, and an amplitude value determiner 408.

The narrow-band speech signal S1 input into the amplitude value estimator 402 is supplied to the average amplitude computing unit 403 and the feature extractor 404.

The average amplitude computing unit 403 calculates an average amplitude AS of the narrow-band speech signal S1. The average amplitude AS is obtained as a scalar value from an N-sample framed signal. A scalar value obtained from a framed signal in this way is herein designated frame data. The average amplitude AS is frame data, and is supplied to the multiplier 407 as a first input.

The feature extractor 404 uses an arbitrary method to compute a feature value F relating to the amplitude of the narrow-band speech signal S1, the spectral shape, or both. The arbitrary method is a method based on, for example, the average amplitude of S1, band division, frequency analysis, LPC analysis, reflection coefficients, or a gradient index. In the first embodiment, the first-order reflection coefficients are used. In addition, the feature value F may be computed using just the current framed signal, or may be computed using the current framed signal in conjunction with one or more previous framed signals. The feature value F thus obtained is supplied to the amplitude value estimating unit 405 and the amplitude ratio estimating unit 406.

The amplitude value estimating unit 405 computes a directly estimated amplitude value AXHa in the extension band by using Eq. (1) with the feature value F. The directly estimated amplitude value AXHa thus obtained is supplied to the amplitude value determiner 408 as a first input.

AXHa=fa(F) (1)

The amplitude ratio estimating unit 406 computes an estimated amplitude ratio RXHr, which is an estimated value for an amplitude ratio obtained by dividing the average amplitude in the extension band by the average amplitude in the input band, by using Eq. (2) with the feature value F. The estimated amplitude ratio RXHr thus obtained is supplied to the multiplier 407 as a second input.

RXHr=fr(F) (2)

The multiplier 407 computes an input band-dependent estimated amplitude value AXHr by multiplying the average amplitude AS in the input band (the first input) by the estimated amplitude ratio RXHr (the second input), and gives the input band-dependent estimated amplitude value AXHr thus obtained to the amplitude value determiner 408 as a second input.

The amplitude value determiner 408 consolidates the directly estimated amplitude value AXHa and the input band-dependent estimated amplitude value AXHr, and computes the determined amplitude value AXH as a final estimated value for the average amplitude in the extension band.

Specifically, the amplitude value determiner 408 applies the smaller of AXHa and AXHr to be AXH. The determined amplitude value AXH thus obtained is supplied to the extension signal amplitude adjuster 414 as a first input.

The upsampling processor 409 includes upsampling and aliasing filtering, and by performing upsampling and aliasing filtering, computes a speech signal XL with 16 kHz sampling having the input band only. The upsampling inserts a zero after each sample in the narrow-band speech signal S1. As a result, a signal with 16 kHz sampling is obtained having aliasing distortion that folds the 0 Hz to 4 kHz components of S1 in the 4 kHz to 8 kHz of the frequency spectrum. By passing this signal having aliasing distortion through an aliasing filter having low-pass characteristics with a 4 kHz cutoff frequency, it is possible to obtain a speech signal XL in which the sampling frequency of the narrow-band speech signal has been upsampled. The speech signal XL thus obtained is supplied to the extension signal generator 410, and additionally supplied to the adder 420 as a first input.

The extension signal generator 410 includes a BPF 411, a full-wave rectifier 412, and an HPF 413. The input speech signal XL is supplied to the BPF 411.

The BPF 411 passes the band from 2 kHz to 4 kHz in the speech signal XL. A band-limited signal XB thus obtained is supplied to the full-wave rectifier 412.

The full-wave rectifier 412, by computing the full-wave rectification of the band-limited signal XB, outputs a wideband signal XW having a band from 0 Hz to 8 kHz. Note that although full-wave rectification is used herein to obtain the wideband signal XW, other methods (such as half-wave rectification, frequency shifting, or aliasing distortion, for example) may also be used to compute the wideband signal XW. The wideband signal XW thus obtained is supplied to the HPF 413.

The HPF 413 passes the band from 4 kHz to 8 kHz in the wideband signal XW. In this manner, an extension signal EH is computed, and supplied to the extension signal amplitude adjuster 414 as a second input.

Note that although the foregoing is described as though the extension signal generator 410 is required to include the BPF 411, the full-wave rectifier 412, and the HPF 413, other configurations are also possible. For example, the BPF 411 may be omitted in the case of using a technique such as frequency shifting or aliasing distortion instead of full-wave rectification, or the HPF 413 may be omitted in the case of using a computation method that attenuates the input band.

The extension signal amplitude adjuster 414 includes an average amplitude computing unit 415, interpolators 416 and 417, a gain calculator 418, and a multiplier 419. The first input, the determined amplitude value AXH, is supplied to the interpolator 417. The second input, the extension signal EH, is supplied to the average amplitude computing unit 415, and is additionally supplied to the multiplier 419 as a first input.

The average amplitude computing unit 415 computes an average amplitude AEH of the extension signal EH, which is the average amplitude in the extension band before interpolation. The extension signal average amplitude AEH thus obtained is supplied to the interpolator 416.

The interpolator 416 interpolates the extension signal average amplitude AEH on a per-sample basis, converting the frame data into an N-sample framed signal AEH1. An arbitrary method may be applied for the interpolation. One good choice for the method is linear interpolation with previous frame data, for example. The average extension signal amplitude interpolation value AEH1 thus obtained is supplied to the gain calculator 418 as a first input.

The interpolator 417 interpolates the determined amplitude value AXH on a per-sample basis, converting the frame data into an N-sample framed signal AXH1. For the interpolation method, the same method as the interpolator 416 is one good choice. An arbitrary method that differs from the interpolator 416 may also be selected. The estimated average amplitude interpolation value AXH1 thus obtained is supplied to the gain calculator 418 as a second input.

For each sample, the gain calculator 418 divides the estimated average amplitude interpolation value AXH1 (the second input) by the extension signal average amplitude interpolation value AEH1 (the first input) to compute an extension gain GH used to adjust the amplitude of the extension signal EH. The extension gain GH thus obtained is supplied to the multiplier 419 as a second input.

The multiplier 419 computes an amplitude-adjusted extension signal XH by multiplying the extension signal EH (the first input) by the extension gain GH (the second input) for each sample. The amplitude-adjusted extension signal XH is supplied to the adder 420 as a second input.

The adder 420 computes a framed signal X1 for the extended wideband speech signal by adding together the speech signal XL (the first input) and the amplitude-adjusted extension signal XH (the second input). The speech signal XL has the components of the narrow-band speech signal S1 from 0 Hz to 4 kHz, whereas the amplitude-adjusted extension signal XH has extension components from 4 kHz to 8 kHz, and thus X1 becomes a wideband speech signal containing both the input band and the extension band. The extended wideband speech signal X1 thus obtained is supplied to the unbuffer 421.

The unbuffer 421 unbuffers the extended wideband speech signal X1 collected every N samples to generate and output an extended wideband speech signal X that is output one by one with a period of 16 kHz.

### (B-2) Advantageous Effects of First Embodiment

As described above, according to the first embodiment, by consolidating the two estimates of an amplitude ratio estimation and an amplitude value estimation, it is possible to more stably and accurately estimate the true average amplitude in the extension band, thus yielding a more natural extended wideband speech signal.

In addition, according to the first embodiment, since the consolidation of the two estimates involves selecting the smaller of the two estimated values, the estimated values do not become discontinuous, unlike techniques that implement some kind of determination switch. Moreover, since the estimated value with the higher estimation accuracy is automatically selected, it is possible to stably and highly accurately estimate the amplitude in the extension band for both unvoiced sound and voiced sound, yielding an extended wideband speech signal with higher clarity.

### (C) Second Embodiment

Next, a band extension apparatus and a band extension method according to a second embodiment of the present invention will be described in detail with reference to the drawings.

### (C-1) Configuration and Operation of Second Embodiment

FIG. 5 is a block diagram illustrating an exemplary configuration of a voice band extension apparatus 500 according to the second embodiment.

In FIG. 5, the voice band extension apparatus 500 of the second embodiment includes the buffer 401, the amplitude value estimator 402, the upsampling processor 409, the extension signal generator 410, an extension signal amplitude adjuster 514, the adder 420, and the unbuffer 421.

Note that in FIG. 5, structural elements identical or corresponding to the first embodiment in FIG. 2 are denoted with the same reference signs, and detailed description of these structural elements will be omitted.

In the second embodiment, the processing of the extension signal amplitude adjuster 514 differs from the first embodiment. The extension signal amplitude adjuster 514 of the second embodiment includes a spectral shape corrector 522, in addition to the average amplitude computing unit 415, the interpolators 416 and 417, the gain calculator 418, and the multiplier 419.

The operation of the extension signal amplitude adjuster 514 is the same as the extension signal amplitude adjuster 414 of the first embodiment up until the multiplier 419 receives the determined amplitude value AXH and the extension signal EH, and computes the amplitude-adjusted extension signal XH. The amplitude-adjusted extension signal XH thus obtained is supplied to the spectral shape corrector 522.

A spectral shape correction filter coefficients FC is pre-designed for the spectral shape corrector 522. The spectral shape corrector 522 corrects the spectral shape of the extension signal XH by filtering the amplitude-adjusted extension signal XH with the spectral shape correction filter coefficients FC.

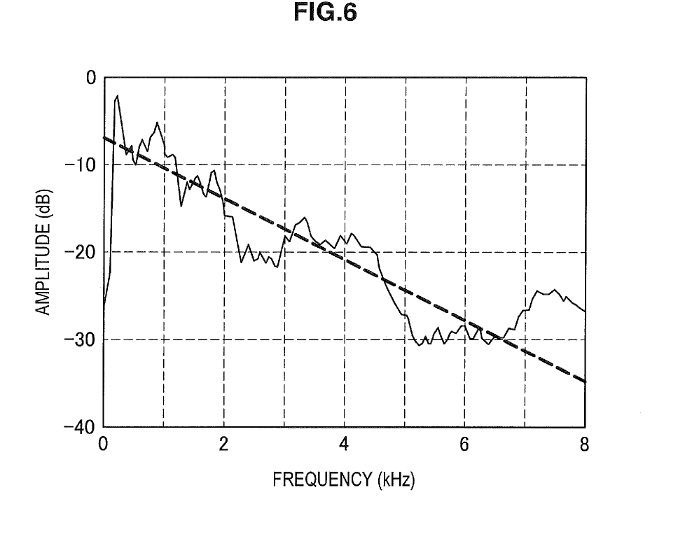

FIG. 6 is a graph illustrating an average amplitude spectrum of speech. In FIG. 6, the amplitude spectrum of the speech is indicated with thin solid lines, and the rough shape of the amplitude spectrum is indicated with a bold broken line. As FIG. 6 demonstrates, the speech signal spectrum declines often as the frequency increases. Given this property, designing the spectral shape correction filter coefficients FC such that the extension signal spectrum declines as the frequency increases is a good choice. Also, when designing the spectral shape correction filter coefficients FC, attention is also paid to the fact that the spectral shapes of the extension signals EH and XH may become characteristic depending on the processing details of the extension signal generator 410. For example, full-wave rectification has the property of strengthening the band near 6 kHz, or aliasing distortion has the property of strengthening the band near 7 kHz to 8 kHz. Note that the spectral shape correction filter coefficients FC may be FIR filter coefficients, and may also be IIR filter coefficients. The extension signal XH1 with a corrected spectral shape as obtained by the spectral shape corrector 522 is supplied to the adder 420 as a second input.

### (C-2) Advantageous Effects of Second Embodiment

As described above, according to the second embodiment, the spectral shape of the extension signal is corrected to a more natural shape, thus yielding an extended wideband speech signal with higher naturalness.

### (D) Third Embodiment

Next, a band extension apparatus and a band extension method according to a third embodiment of the present invention will be described with reference to the drawings.

### (D-1) Configuration and Method of Third Embodiment

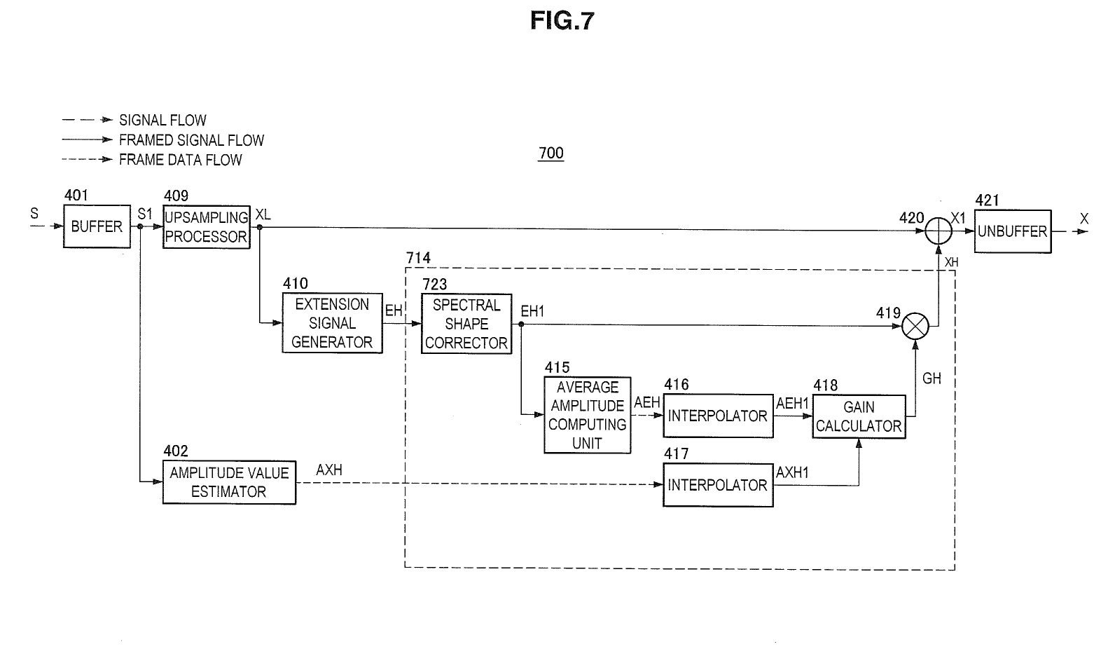

FIG. 7 is a block diagram illustrating an exemplary configuration of a voice band extension apparatus 700 according to the third embodiment.

In FIG. 7, the voice band extension apparatus 700 of the third embodiment includes the buffer 401, the amplitude value estimator 402, the upsampling processor 409, the extension signal generator 410, an extension signal amplitude adjuster 714, the adder 420, and the unbuffer 421.

Note that in FIG. 7, structural elements identical or corresponding to the first embodiment in FIG. 2 are denoted with the same reference signs, and detailed description of these structural elements will be omitted.

The extension signal amplitude adjuster 714 of the third embodiment includes a spectral shape corrector 723, the average amplitude computing unit 415, the interpolators 416 and 417, the gain calculator 418, and the multiplier 419.

The operation of the extension signal amplitude adjuster 714 is the same as the extension signal amplitude adjuster 414 according to the first embodiment, except that whereas the input into the average amplitude computing unit 415 and the first input into the multiplier 419 are the extension signal EH in the first embodiment, in the third embodiment these inputs are an extension signal EH1 with corrected spectral shape as obtained from the spectral shape corrector 723 discussed later. The extension signal EH input into the extension signal amplitude adjuster 714 is supplied to the spectral shape corrector 723.

The spectral shape corrector 723 includes pre-designed spectral shape correction filter coefficients FC, and corrects the spectral shape of the extension signal EH by filtering the extension signal EH with the spectral shape correction filter coefficients FC. In fact, the spectral shape corrector 723 corrects the spectral shape of the extension signal EH before the average amplitude of the extension signal is adjusted.

The spectral shape correction filter coefficients FC are designed with a similar methodology as the second embodiment. The extension signal EH1 with corrected spectral shape as obtained by the spectral shape corrector 723 is supplied to the average amplitude computing unit 415, and is additionally supplied to the multiplier 419 as a first input.

### (D-2) Advantageous Effects of Third Embodiment

As described above, according to the third embodiment, since the spectral shape of the extension signal is corrected before adjusting the average amplitude of the extension signal, it is possible to adjust the average amplitude closer to the true average amplitude in the extension band while also correcting the spectral shape of the amplitude-adjusted extension signal XH to a more natural shape, thus yielding an extended wideband speech signal with higher naturalness.

### (E) Fourth Embodiment

Next, a band extension apparatus and a band extension method according to a fourth embodiment of the present invention will be described with reference to the drawings.

### (E-1) Configuration and Operation of Fourth Embodiment

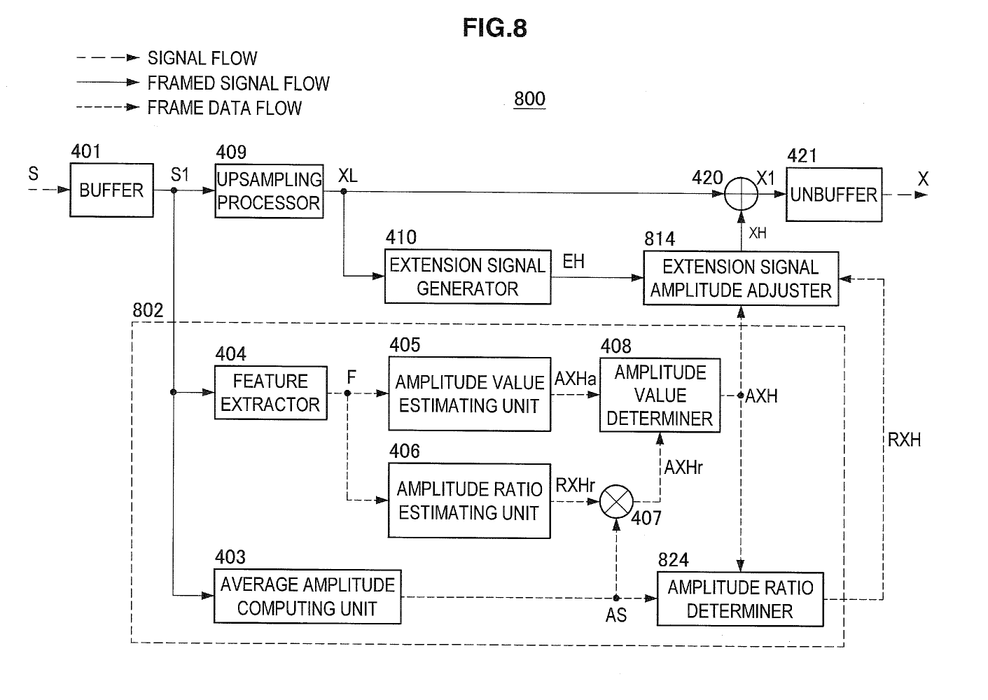

FIG. 8 is a block diagram illustrating an exemplary configuration of a voice band extension apparatus 800 according to the fourth embodiment.

In FIG. 8, the voice band extension apparatus 800 of the fourth embodiment includes the buffer 401, an amplitude value estimator 802, the upsampling processor 409, the extension signal generator 410, an extension signal amplitude adjuster 814, the adder 420, and the unbuffer 421.

Note that in FIG. 8, structural elements identical or corresponding to the first embodiment in FIG. 2 are denoted with the same reference signs, and detailed description of these structural elements will be omitted.

The amplitude value estimator 802 of the fourth embodiment includes an amplitude ratio determiner 824, in addition to the average amplitude computing unit 403, the feature extractor 404, the amplitude value estimating unit 405, the amplitude ratio estimating unit 406, the multiplier 407, and the amplitude value determiner 408.

The operation of the amplitude value estimator 802 is the same as the amplitude value estimator 402 according to the first embodiment in that these estimators receive a narrow-band speech signal S1 as input and compute the average amplitude AS in the input band and the determined amplitude value AXH. The average amplitude AS and the determined amplitude value AXH thus obtained are supplied to the amplitude ratio determiner 824.

By dividing the determined amplitude value AXH (the second input) by the average amplitude AS (the first input), the amplitude ratio determiner 824 computes a determined amplitude ratio RXH, the final estimated value for the ratio of the average amplitude in the extension band divided by the average amplitude in the input band. The determined amplitude ratio RXH thus obtained is supplied to the extension signal amplitude adjuster 814 as a third input.

For the extension signal amplitude adjuster 814, the extension signal amplitude adjuster 414 according to the first embodiment, the extension signal amplitude adjuster 514 according to the second embodiment or the extension signal amplitude adjuster 714 according to the third embodiment may be applied.

The extension signal amplitude adjuster 814 receives the determined amplitude ratio RXH as the third input from the amplitude ratio determiner 824. By giving this determined amplitude ratio RXH to the spectral shape corrector 522 or 723, the spectral shape correction filter coefficients FC become variable.

Operation other than making the spectral shape correction filter coefficients FC variable is the same as the extension signal amplitude adjuster 514 according to the second embodiment or the extension signal amplitude adjuster 714 according to the third embodiment.

In the second embodiment and the third embodiment, the extension signal amplitude adjusters 514 and 714 correct the spectral shape of the extension signal to a more natural shape by utilizing the observation that in most cases the spectral shape of speech declines as the frequency increases as in FIG. 6.

However, although the spectral shape of speech does decline as the frequency increases in the case of voiced sound, the spectral shape rises in the case of unvoiced sound, as illustrated in FIGS. 3 and 4. Also, as illustrated in FIG. 4, the spectral shape of unvoiced sound is flat from 4 kHz to 8 kHz. Given the above properties, the spectral shape corrector 522 or 723 of the extension signal amplitude adjuster 814 is able to more closely approach the true spectral shape in the extension band by correcting the spectral shape of the extension signal to decline as the frequency increases in the case of a small determined amplitude ratio RXH, and correcting the spectral shape of the extension signal to stay flat in the case of a large determined amplitude ratio RXH.

An arbitrary method may be used as the method of determining the spectral shape correction filter coefficients FC. A good choice for the arbitrary method is the two following methods. The first method designs at least two or more types of filter coefficients FC in advance. This method defines some threshold values Th (the number of the threshold values Th is one less than the number of the filter coefficient types) with respect to the determined amplitude ratio RXH in advance, and selects predetermined filter coefficients FC on the basis of the magnitude relation between RXH and Th. The second method adapts the filter coefficients FC on the basis of the determined amplitude ratio RXH. This method defines FC as a second-order FIR filter, designs an arbitrary function ff that scales RXH into the range from 0 to 0.5, and sets first and second coefficients of FC to (1-ff(RXH)) and ff(RXH), respectively.

### (E-2) Advantageous Effects of Fourth Embodiment

As described above, according to the fourth embodiment, the spectral shape of the extension signal is adaptively corrected on the basis of the amplitude ratio between the input band and the extension band, thus yielding an extended wideband speech signal with higher naturalness.

### (F) Fifth Embodiment

Next, a band extension apparatus and a band extension method according to a fifth embodiment of the present invention will be described with reference to the drawings.

### (F-1) Configuration and Operation of Fifth Embodiment

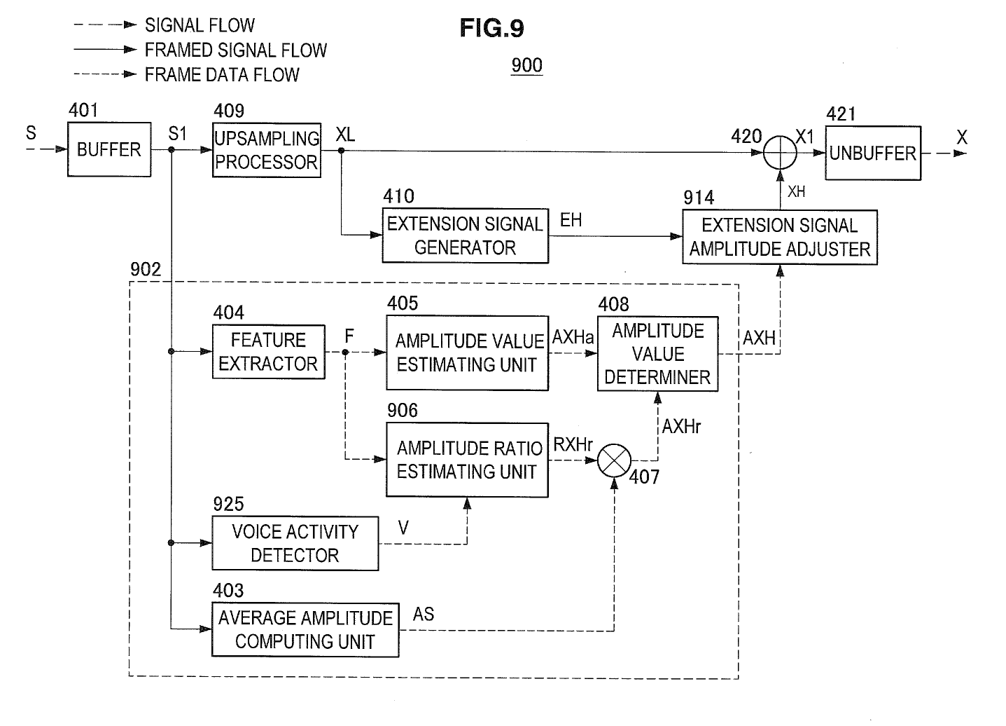

FIG. 9 is a block diagram illustrating an exemplary configuration of a voice band extension apparatus 900 according to the fifth embodiment.

In FIG. 9, the voice band extension apparatus 900 of the fifth embodiment includes the buffer 401, an amplitude value estimator 902, the upsampling processor 409, the extension signal generator 410, an extension signal amplitude adjuster 914, the adder 420, and the unbuffer 421.

Note that in FIG. 9, structural elements identical or corresponding to the first embodiment in FIG. 2 are denoted with the same reference signs, and detailed description of these structural elements will be omitted.

The amplitude value estimator 902 of the fifth embodiment includes the average amplitude computing unit 403, the feature extractor 404, the amplitude value estimating unit 405, a voice activity detector 925, an amplitude ratio estimating unit 906, the multiplier 407, and the amplitude value determiner 408.

The amplitude value estimator 902 is the same as the amplitude value estimator 402 according to the first embodiment, except for the new addition of the voice activity detector 925. However, since the number of inputs and functionality for the amplitude ratio estimating unit 906 are different, the reference sign of this unit is changed from the amplitude ratio estimating unit 406 according to the first embodiment.

A narrow-band speech signal S1 input into the amplitude value estimator 902 is input into the average amplitude computing unit 403, the feature extractor 404, and the voice activity detector 925. Thereafter, the operation of the feature extractor 404, the amplitude value estimating unit 405, the multiplier 407, and the amplitude value determiner 408 is the same as in the first embodiment, and thus detailed description is omitted.

The voice activity detector 925 determines, on the basis of an input narrow-band speech signal S1, whether the narrow-band speech signal S1 is a voiced segment (also called the target segment) or an unvoiced segment (a silent segment or noise segment, also called a non-target segment). The output V from the voice activity detector 925 may be a truth value indicating a voiced segment or not, or may also be a real value from 0 to 1 that represents the likelihood of being a voiced segment (the probability of being a voiced segment). The voiced activity determination value V thus obtained is supplied to the amplitude ratio estimating unit 906 as a second input.

The amplitude ratio estimating unit 906 computes the estimated amplitude ratio RXHr, by using Eq. (3) with three values and two functions as follows: the feature value F (the first input), the voiced activity determination value V (the second input), a preset threshold value Vthr with respect to V, the function fr defined in the first embodiment, and a newly defined function fv. The estimated amplitude ratio RXHr thus obtained is supplied to the multiplier 407 as a second input.

$$RXHr = \{ \begin{matrix}fr ( F ) , if V > Vthr \\ fr ( F ) , if V <= Vthr and fr ( F ) < fv ( V ) \\ fv ( V ) , otherwise\end{matrix} \qquad ( 3 )$$

The amplitude value determiner 408 consolidates the directly estimated amplitude value AXHa received from the amplitude value estimating unit 405 and the input band-dependent estimated amplitude value AXHr received from the multiplier 407, and computes the determined amplitude value AXH, which is a final estimated value for the average amplitude in the extension band. The method of computing the determined amplitude value AXH involves applying the determined amplitude value AXH to be the smaller of AXHa and AXHr, similarly to the first embodiment.

For the extension signal amplitude adjuster 914, the extension signal amplitude adjuster 514 according to the second embodiment or the extension signal amplitude adjuster 714 according to the third embodiment may be applied.

### (F-2) Advantageous Effects of Fifth Embodiment

As described above, according to the fifth embodiment, it is possible to give a safe estimated amplitude value even in the case where estimation of the average amplitude of the extension is not conducted correctly in an unvoiced segment, thus yielding a highly stable extended wideband speech signal.

### (G) Sixth Embodiment

Next, a band extension apparatus and a band extension method according to a sixth embodiment of the present invention will be described with reference to the drawings.

### (G-1) Configuration and Operation of Sixth Embodiment

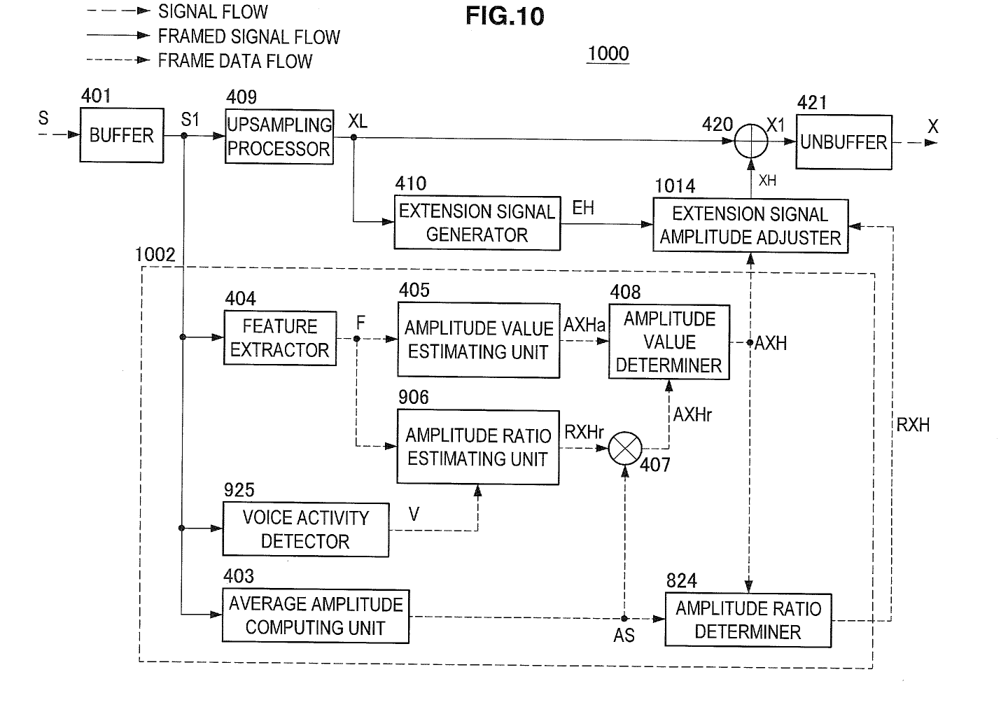

FIG. 10 is a block diagram illustrating an exemplary configuration of a voice band extension apparatus 1000 according to the sixth embodiment.

In FIG. 10, the voice band extension apparatus 1000 of the sixth embodiment includes the buffer 401, an amplitude value estimator 1002, the upsampling processor 409, the extension signal generator 410, an extension signal amplitude adjuster 1014, the adder 420, and the unbuffer 421.

Note that in FIG. 10, structural elements identical or corresponding to the first embodiment in FIG. 2 are denoted with the same reference signs, and detailed description of these structural elements will be omitted.

The amplitude value estimator 1002 of the sixth embodiment includes the average amplitude computing unit 403, the feature extractor 404, the amplitude value estimating unit 405, the voice activity detector 925, the amplitude ratio estimating unit 906, the multiplier 407, the amplitude value determiner 408, and the amplitude ratio determiner 824.

The amplitude value estimator 1002 is the same as the amplitude value estimator 402 according to the first embodiment, except for the inclusion of the amplitude ratio determiner 824 according to the fourth embodiment, as well as the voice activity detector 925 and amplitude ratio estimating unit 906 according to the fifth embodiment.

The operation of each component of the amplitude value estimator 1002 is the same as the respective components in the first embodiment, the fourth embodiment, and the fifth embodiment with the same corresponding reference signs. The amplitude value estimator 1002 computes a determined amplitude value AXH made stable by the voice activity detector 925, as well as a determined amplitude ratio RXH made similarly stable, and the two frame data thus obtained are supplied to the extension signal amplitude adjuster 1014.

For the extension signal amplitude adjuster 1014, any of the extension signal amplitude adjuster 514 according to the second embodiment, the extension signal amplitude adjuster 714 according to the third embodiment, and the extension signal amplitude adjuster 814 according to the fourth embodiment may be applied.

The operation of the extension signal amplitude adjuster 1014 is the same as any of the extension signal amplitude adjuster 514, the extension signal amplitude adjuster 714, and the extension signal amplitude adjuster 814, except that the determined amplitude ratio RXH (the third input) is ignored in the case where the extension signal amplitude adjuster 1014 is the same as the extension signal amplitude adjuster 514 or the extension signal amplitude adjuster 714.

### (G-2) Advantageous Effects of Sixth Embodiment

As described above, according to the sixth embodiment, it is possible to stably estimate the average amplitude in the extension band even in unvoiced segments, and in addition, use a stable estimated value for the ratio of the average amplitude in the input band and the average amplitude in the extension band to make the spectral shape of the extension signal more closely approach the true shape, thus yielding a stable and highly natural extended wideband speech signal.

### (H) Other Embodiments

Although various modified embodiments are described in the foregoing first through sixth embodiments, the present invention may also be applied to other modified embodiments such as the following.

### (H-1)

In the foregoing first through sixth embodiments, the extension signal generator 410 is described as generating the extension signal EH by using only the upsampled speech signal XL. However, it is also possible for the extension signal generator to include a noise generator that outputs a noise signal having signal components in the extension band and an adder as structural elements, such that the extension signal EH and a noise signal output by the noise generator are input into the adder, with the signal obtained by the adder adding together the extension signal EH and the noise signal being applied as a new extension signal EH.

### (H-2)

Also, the above extension signal generator equipped with a noise generator and an adder may also receive, as a second input, a voiced activity determination value V output by the voice activity detector 925 in the fifth embodiment and the sixth embodiment, and a noise amplitude adjuster may be inserted between the noise generator and the adder, such that noise amplitude adjuster multiplies the noise signal by a noise gain based on the voiced activity determination value V, and the adder adds the result to the extension signal.

### (H-3)

Also, although each of the foregoing first through sixth embodiments is described as though required to process signals in units of frames, the units of processing in the algorithms may also be set to samples. In this case, although the actual processing is conducted in units of frames, the processing to compute the average amplitude of a framed signal is substituted with smoothing by a moving average or time constant filter, for example. Furthermore, the processing of the feature extractor is also switched from processing in units of frames to filter processing as appropriate. These processing results are then input and output as framed signals rather than frame data, and processed in individual samples. Obviously, the interpolators are removed from the configuration, being unnecessary. By applying such modifications, the computational load typically increases, but the delay in the algorithm due to the interpolators can be reduced.

### (H-4)

In the foregoing first through sixth embodiments, each structural element is envisioned as being realized in hardware and described accordingly. However, all or part of each structural element in each embodiment may also be executed in software.

### (H-5)

In the foregoing first through sixth embodiments, the case of extending a speech signal is given as an example, but acoustic signals other than speech signals may also be extended.

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. A band extension apparatus that extends a narrow-band speech signal whose frequency band has been restricted to an arbitrary input band, so as to include signal components in an arbitrary extension band that is a frequency band outside the input band, the band extension apparatus comprising:
an average amplitude computing unit configured to compute a short-term average amplitude of the narrow-band speech signal from the narrow-band speech signal;
a feature extractor configured to compute, from the narrow-band speech signal, a feature value relating to either or both of an amplitude of the narrow-band speech signal and a spectral shape in the input band;
an amplitude value estimating unit configured to compute a directly estimated amplitude value by directly estimating the short-term average amplitude in the extension band on the basis of the feature value obtained from the feature extractor;
an amplitude ratio estimating unit configured to compute, on the basis of the feature value obtained from the feature extractor, an estimated amplitude ratio that is an estimated value for a ratio of the short-term average amplitude in the extension band divided by the short-term average amplitude in the input band;
a multiplier configured to compute an input band-dependent estimated amplitude value, which is the short-term average amplitude in the extension band, by multiplying the short-term average amplitude in the input band by the estimated amplitude ratio;
an amplitude value determiner configured to compute, on the basis of the directly estimated amplitude value and the input band-dependent estimated amplitude value, a determined amplitude value as a final estimated value for the short-term average amplitude in the extension band;
an extension signal generator configured to generate, on the basis of the narrow-band speech signal, an extension signal having the signal components in the extension band;
an extension signal amplitude adjuster configured to adjust the amplitude of the extension signal such that the short-term average amplitude of the extension signal becomes the determined amplitude value; and
an adder configured to add the narrow-band speech signal to the extension signal whose amplitude is adjusted by the extension signal amplitude adjuster.

2. The band extension apparatus according to claim 1,
wherein the extension signal amplitude adjuster includes a spectral shape corrector configured to correct the spectral shape of the extension signal.

3. The band extension apparatus according to claim 2,
wherein the spectral shape corrector corrects the spectral shape of the extension signal after the short-term average amplitude of the extension signal is adjusted.

4. The band extension apparatus according to claim 2,
wherein the spectral shape corrector corrects the spectral shape of the extension signal before the short-term average amplitude of the extension signal is adjusted.

5. The band extension apparatus according to claim 2, further comprising:
an amplitude ratio determiner configured to compute a determined amplitude ratio by dividing the determined amplitude value by the short-term average amplitude of the narrow-band speech signal;
wherein the extension signal amplitude adjuster adjusts characteristics of the spectral shape corrector on the basis of the determined amplitude ratio.

6. The band extension apparatus according to claim 1, further comprising:
a voice activity detector configured to detect, on the basis of the narrow-band speech signal, whether or not the narrow-band speech signal is a voiced segment;
wherein the amplitude ratio estimating unit computes the estimated amplitude ratio on the basis of the feature value and a voiced activity determination value obtained from the voice activity detector.

7. The band extension apparatus according to claim 6,
wherein the voiced activity determination value is a truth value.

8. The band extension apparatus according to claim 6,
wherein the voiced activity determination value is a real value.

9. A band extension method of extending a narrow-band speech signal whose frequency band has been restricted to an input band, so as to include signal components in an arbitrary extension band that is a frequency band outside the input band, the band extension method comprising:
computing a short-term average amplitude of the narrow-band speech signal from the narrow-band speech signal;
computing, from the narrow-band speech signal, a feature value relating to either or both of an amplitude of the narrow-band speech signal and a spectral shape in the input band;
computing a directly estimated amplitude value by directly estimating the short-term average amplitude in the extension band on the basis of the feature value;
computing, on the basis of the feature value, an estimated amplitude ratio that is an estimated value for a ratio of the short-term average amplitude in the extension band divided by the short-term average amplitude in the input band;
computing an input band-dependent estimated amplitude value, which is the short-term average amplitude in the extension band, by multiplying the short-term average amplitude in the input band by the estimated amplitude ratio;
computing, on the basis of the directly estimated amplitude value and the input band-dependent estimated amplitude value, a determined amplitude value as a final estimated value for the short-term average amplitude in the extension band;
generating, on the basis of the narrow-band speech signal, an extension signal having the signal components in the extension band;
adjusting the amplitude of the extension signal such that the short-term average amplitude of the extension signal becomes the determined amplitude value; and
adding the narrow-band speech signal to the extension signal whose amplitude is adjusted.
